(19) United States
(12) Patent Application Publication
(10) Pub. No.: US 2010/0293294 A1
(43) Pub. Date: Nov. 18, 2010

(54) PEER-TO-PEER COMMUNICATION OPTIMIZATION

(75) Inventors: Volker F. Hilt, Middletown, NJ (US); Ivica Rimac, Tinton Falls, NJ (US)

Correspondence Address: MENDELSOHN, DRUCKER, & ASSOCIATES, P.C., 1500 JOHN F. KENNEDY BLVD., SUITE 405, PHILADELPHIA, PA, 19102, US

(73) Assignee: Alcatel-Lucent USA Inc., Murray Hill, NJ (US)

(21) Appl. No.: 12/466,505

(22) Filed: May 15, 2009

(51) Int. Cl. G06F 15/16

(52) U.S. Cl. 709/241; 709/204; 709/224; 709/217

(57) ABSTRACT

A peer-to-peer communication optimizer uses both peer locality and content diversity in a peer group to reduce network usage cost associated with using remote peers in a peer-to-peer system while reducing impact on the download time relative to peer-to-peer protocols operating with locality optimization alone or no localization of peers. The optimizer intercepts control messages in the peer-to-peer system and substitutes peer lists that meet both diversity indicator and network usage cost thresholds. Transparent embodiments operate without requirement to change peer or tracker implementations. Such embodiments include control message redirection, interception, and modification transparent to the client and tracker applications. Other embodiments include proxy designation. Still other embodiments include the use of gateway peers selected as function of diversity of content and network topology. Still other embodiments involve modification to one or more of client and/or tracker software and potentially the use of a standard interface for network topology determination.

### BACKGROUND

1. Field of the Invention

The present invention relates to peer-to-peer communications, and, in particular, to optimization of peer-to-peer communications based on localization of traffic between peers within a specified domain.

2. Description of the Related Art

This section introduces aspects that may help facilitate a better understanding of the invention(s). Accordingly, the statements of this section are to be read in this light and are not to be understood as admissions about what is in the prior art or what is not in the prior art.

Peer-to-peer (P2P) file-sharing networks are used to distribute large amounts of data between users on a network. BitTorrent, one of the most common protocols for transferring large files on the Internet, is estimated to account for about 25% to 35% of all Internet traffic.

In a typical P2P file-sharing scenario, a content file (e.g., movie or application) is seeded to one or more P2P clients running on host(s) connected to a network, and a tracking file (e.g., a “torrent” file in a BitTorrent network) is distributed that identifies the content file and tracking hosts (aka “trackers”) that can provide information on how to contact clients sharing the content file (i.e., the seeded P2P clients, as well as other clients that may have copies of fragments of the content file). Peers obtain various fragments of the content file and share these fragments with other peers until all peers interested in the content obtain copies of all fragments, and hence have a complete copy of the content. Sharing continues even after the original seeded content file has been removed. Trackers keep track of clients (peers) who are interested in obtaining and hosting fragments of the content file, and each peer communicates with other peers to announce which fragments they can provide and determine which fragments they can receive. Peers then exchange fragments in a “tit-for-tat” sharing scheme that attempts to maintain parity between the amount of data received and the amount of data given (hence the “peer” concept). Peers involved in content-fragment exchanges for a particular content file are sometimes referred to as a “swarm” related to that content file.

Traditionally, P2P clients are network-topology agnostic. In other words, they do not care whether a peer they seek a content fragment from is on the same local network as they are on, or on a remote network, potentially only reachable via an expensive transit link. For example, when a peer that uses the BitTorrent protocol requests a particular content file, a traditional BitTorrent tracker node will return a list of (typically 50) randomly selected peer nodes that have or are interested in obtaining a fragment of the requested content file. The performance of the BitTorrent protocol is derived, in part, from this randomness of peer selection, which generally results in a fair, non-sequential distribution of fragments. The requesting peer node may connect to any other peer node on the list to attempt to obtain the requested content. If the requesting peer node is located within the network of a first Internet Server Provider (ISP), and the other peer node is part of a network of a second ISP, then the second ISP may charge the first ISP for carrying traffic that terminates in the second ISP network.

To avoid such charges and/or generally minimize these or other costs (e.g., network congestion) associated with access of these remote peers, some attempts have been made to localize traffic or constrain the behavior of peer-to-peer protocols so that they limit data transfer to mostly nodes within the same domain (e.g., ISP, region, or autonomous system).

For example, some have suggested using information from routers to determine which peers are local and which are remote from each other. Modifications may then be made at the application layer (affecting the operation of the peers) or at the network layer (transparently to the peers) to direct peers to participate in data exchanges to a greater extent with peers that are within their network than with peers that are outside their network. More information on one such scheme can be found, for example, in US Pat. Pub. 2007/0064702, “Modifying Operation of Peer-to-Peer Networks based on Integrating Network Routing Information,” incorporated herein by reference in its entirety.

Such topology-only approaches to P2P traffic localization are not optimal, however, because the forced localization tends to work against the benefits of peer-selection randomization, which is a key aspect of P2P protocols. Additionally, and importantly, these techniques fail to appropriately address the P2P content layer.

### SUMMARY

In one embodiment, the present invention is a computer-implemented method for selecting peers in a peer-to-peer (P2P) network that involves (a) selecting a subset of peers from a set of peers as a function of both (i) diversity of content and (ii) locality; and (b) generating a P2P control message identifying the selected subset of peers.

In another embodiment, the present invention is a peer-to-peer (P2P) communication optimizer that includes facility for (a) selecting a subset of peers from a set of peers as a function of both (i) diversity of content and (ii) locality; and (b) generating a P2P control message identifying the selected subset of peers.

In another embodiment, the present invention is a peer-to-peer (P2P) network that includes a set of peers and a P2P communication optimizer, the optimizer configured to (a) select, in response to a P2P request message transmitted from a first peer in the set, a subset of peers from the set of peers as a function of both (i) diversity of content and (i) locality, and (b) generate a P2P control message identifying the selected subset of peers, wherein the P2P control message is transmitted to the first peer.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 is a block diagram of a P2P communication network that spans at least two autonomous systems according to various embodiments of the present invention.

FIG. 2 is a flow diagram illustrating a general exemplary method of selecting peers according to various embodiments of the present invention.

FIG. 3 is a flow diagram illustrating details of an exemplary method for selecting peers according to step 220 of FIG. 2.

FIG. 4 is a sequence diagram illustrating a system for selecting peers and message sequencing between elements of that system according to various embodiments of the present invention.

### DETAILED DESCRIPTION

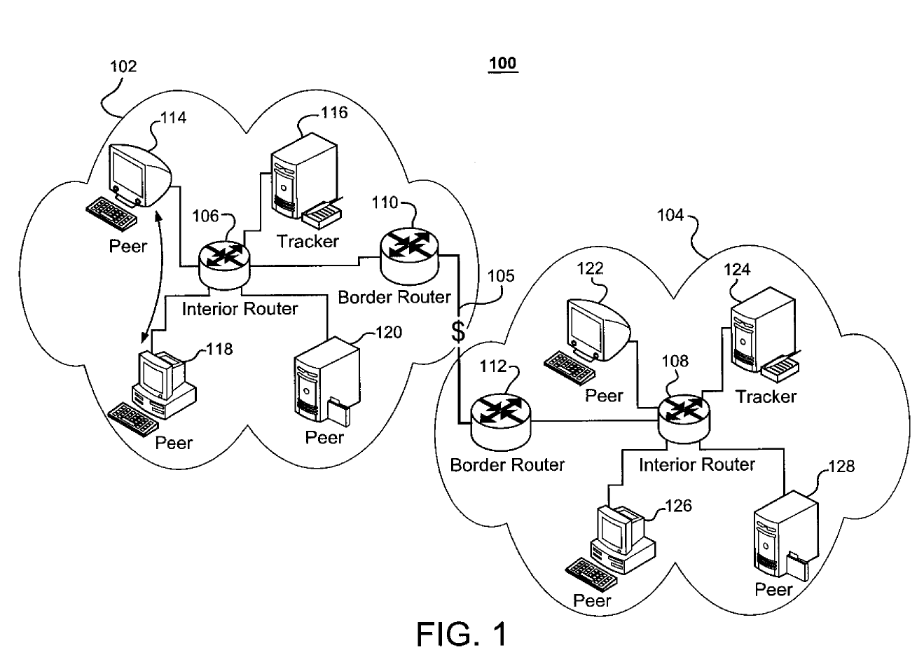

FIG. 1 is a block diagram of peer-to-peer (P2P) communication network 100 according to various embodiments of the present invention. Network 100 includes autonomous systems 102 and 104, which are connected to each other by at least transit link 105, which carries traffic between the autonomous systems. Note that, in FIG. 1, each autonomous system is used to illustrate the concept of a localized network or domain, e.g., a set of resources that belongs to a single ISP. In general, however, there may be multiple autonomous systems per ISP or multiple ISPs per autonomous system. An autonomous system may span multiple logical and/or geographical regions, or there may be multiple autonomous systems per region.

Each autonomous system may include multiple routers (e.g., interior routers 106 and 108, and exterior (i.e., border) routers 110 and 112) and hosts (e.g., hosts 114, 116, 118, 120, 122, 124, 126, and 128). Each router may support various routing protocols. For example, interior routers 106 and 108 may run an interior gateway protocol, such as the Open Shortest Path First (OSPF) protocol or the Intermediate System-to-Intermediate System (IS-IS) protocol, while exterior routers, such as exterior routers 110 and 112, may run an exterior gateway protocol, such as Border Gateway Protocol (BGP).

Each host may run server application software, client application software, or other application software as appropriate in support of the network and the host. Hosts may come in different varieties and run different operating systems. Hosts may include workstations (e.g., Linux workstations), personal computers (e.g., Macintosh or WinTel PCs), network appliances, or mobile devices such as Internet-ready cellphones, PDAs, MP3 players, etc., the latter potentially tied into an autonomous system via wireless interfaces (e.g., 802.11b/g). However, of primary concern, in the case of P2P communications systems, are hosts that run application software for P2P file sharing. Hosts that run client applications for P2P networks will herein be referred to a “peers,” and hosts that run tracking services in support of P2P networks will herein be referred to as “trackers.”

Though embodiments of the present invention are applicable generally to a wide diversity of P2P file-sharing systems, for clarity, these embodiments will be described with respect to one particularly popular file-sharing system (protocol) known as BitTorrent. The BitTorrent protocol is the product of BitTorrent, Inc., San Francisco, Calif. More information on the BitTorrent protocol can be found in “The BitTorrent protocol specification,” final version 11031, Jan. 10, 2008, incorporated herein by reference in its entirety. Those skilled in the art will appreciate that the invention may apply to a wide variety of related P2P systems including eDonkey/Overnet, Shareaza, WinNX, Limewire, Morpheus, emule, Ares, Bearshare, and Kazaa. More information on these P2P systems can be found at Http://compnetworking.about.com/od/p2ppeertopeer/tp/p2pfilesharing.htm, the contents of which are incorporated herein by reference in their entirety.

Referring back to FIG. 1, it should be noted that there exist paths between all hosts but that not all paths are equal. For example, the path between host 114 and host 118 is shorter than the path between host 114 and host 126 in that the only router in the path between host 114 and host 118 is interior router 106, while the path between host 114 and host 126 includes not only interior router 106 but also exterior routers 110 and 112 and interior router 108. Referring to each pass through a router as a hop, the path between hosts 114 and 118 has one hop, while the path between hosts 114 and 126 has four hops. If a cost is associated with each hop, a cumulative cost for a path may be calculated as the number of hops in the path multiplied by the cost per hop.

Another measure of the cost of a route or path can be arrived at by considering the links in the path. For example, the path between host 114 and host 118 includes the link between host 114 and router 106 in addition to the link from router 106 to host 118. The path between host 114 and host 126, however, includes the interior link from host 114 to router 106, the interior link from router 106 to router 110, the exterior transit link from router 110 to router 112, the interior link from router 112 to router 108, and the interior link from router 108 to host 126. Note that exterior transit link 105 between border router 110 and border router 112 (i.e., between autonomous system 102 and autonomous system 104) may have a much higher cost, in general, than each interior link.

Additionally, the interior link between router 106 and router 110 may be more expensive than the interior link between host 114 and router 106 because the former may carry more traffic (and therefore be more congested) than the latter. Thus, in general, the cost for a path may be calculated from at least a sum of weighted costs for the hops in the path plus the sum of weighted costs for the links in the path. However, as can be appreciated, the cost of a path can be calculated in many different ways and depend on a number of different factors, including service-level agreements that exist between ISPs and network clients, and various topological issues.

Herein, the term “network usage cost” will be used to describe the cost of communication as a function of topology. Suffice it to say that local communication (i.e., communication within a domain/autonomous system/ISP) will generally be less expensive than remote communication (i.e., communication between domains), and, for this reason, limiting at least some portion of P2P communication to local communication can be beneficial.

Clearly, the network usage cost associated with P2P communication can be minimized to zero by preventing P2P communication entirely, but such a policy would be viewed very unfavorably by file-sharing peers as well as net-neutrality advocates. Thus, using network topological information to select peers that may communicate with each other, where some fraction of those peers are remote (e.g., in a separate domain) and some fraction of those peers are local, accomplishes a goal of reducing network usage cost while allowing P2P communication to continue. However, policies that use a fixed ratio of remote and local peers have been shown to be non-optimal and may lead to unnecessarily inflated download times.

Therefore, in various embodiments of the present invention, one or more additional criteria regarding the peers are used in the peer-selection process to meet the dual objectives of reducing network usage cost while minimizing impact to the file-sharing protocol. In particular, it can readily be shown that, if a set of peers are selected that have a high diversity of content fragments distributed among those peers, then download times for the complete content will generally be less for those peers than download times for a set of peers selected without consideration of fragment diversity and also less than download times for a set of peers that have a relatively low diversity of fragments.

Diversity can be measured in a number of different ways, each relevant to a variant of the present invention. The idea here is to get a consistent measure of the richness and evenness of the distribution of fragments for use in helping to determine which peers to select for an effective peer group. Richness is a measure of the number of different fragments present in a particular set of peers, and evenness compares the similarity of the number of copies of each fragment to the number of copies of every other fragment to see how evenly distributed the fragments are among peers.

One method of measuring diversity is based on Simpson's index D, expressed as:

$$D = 1 - \frac{{\sum }_{i = 1}^{F} {n}_{i} ( {n}_{i} - 1 )}{N ( N - 1 )}$$

where nᵢ is the number of copies of fragment i in a set of peers, F is the total number of unique fragments for a content file, and N is the sum total number of all fragments for the content file distributed among the peers.

Other indices for diversity may also be used, as would be understood by one skilled in the art, including the Berger-Parker index, the Renyi entropy index, and Shannon's diversity index H, the latter of which is expressed as:

$$H = - {\sum }_{i = 1}^{F} {p}_{i} ln ( {p}_{i} )$$

where pᵢ is the ratio n/N.

Thus, in one embodiment of the present invention, a peer exchange may be used with each peer in a candidate set of peers to determine the specific fragments present in the candidate set of peers. The candidate set may include both local and remote peers. A set of all local peers may first be selected from the candidate set. Through experimentation, a diversity index threshold is determined that is correlated with an acceptable download time or expansion of download time relative to ideal or unmodified P2P activity. If the diversity index threshold cannot be achieved using only local peers in the set, then select remote peers are allowed into the set until the diversity index is met. The protocol is then allowed to operate as usual with the constraint that the random selection of peers is allowed to occur only within the selected set of peers.

In the BitTorrent protocol, there are two types of communication. The first is between a peer and a tracker, and the second is between a peer and another peer. More information on BitTorrent communication can be found in “BitTorrent Protocol Specification v1.0 Overview” at http://wiki.theory.org/BitTorrentSpecification#Overview, incorporated herein by reference in its entirety. It is only in the second type of communication between peers that information is communicated regarding specifically which fragments are available on each peer. It is thus only in these cases that explicit information about fragment distribution within a candidate set of peers is available for use in the diversity calculation. One embodiment of the present invention (not illustrated) involves such a peer-to-peer querying process.

In various alternative embodiments, however, an estimator for diversity is used. In a peer-to-tracker communication, a peer will announce its interest in a particular content file via a request message to the tracker, and the tracker will respond with a random list of peers that are also interested in that content file and may be contacted to attempt peer-to-peer exchange for the content. The request message also includes a “bytes-left” count for the peer, which indicates how many bytes short the peer is of a complete download of the content file. Subtracting the bytes-left value from the file size allow the tracker to determine the bytes stored by a peer of a content file.

With only the bytes-stored information, however, it is not possible to determine which specific fragments are present in each peer, or a peer candidate set, but only the total number of fragments. Due to the randomness in the set of peers selected by the BitTorrent protocol, however, and given that no peers store more than one copy of any specific fragment for any given content file, a good estimate of the diversity of a candidate set of peers can be arrived at by summing the bytes stored by the peers in the set. In some embodiments, this sum is calculated and used as a basis, in addition to locality information, for selecting a set of peers to be used for a swarm that meets a diversity index established to ensure reasonable download times.

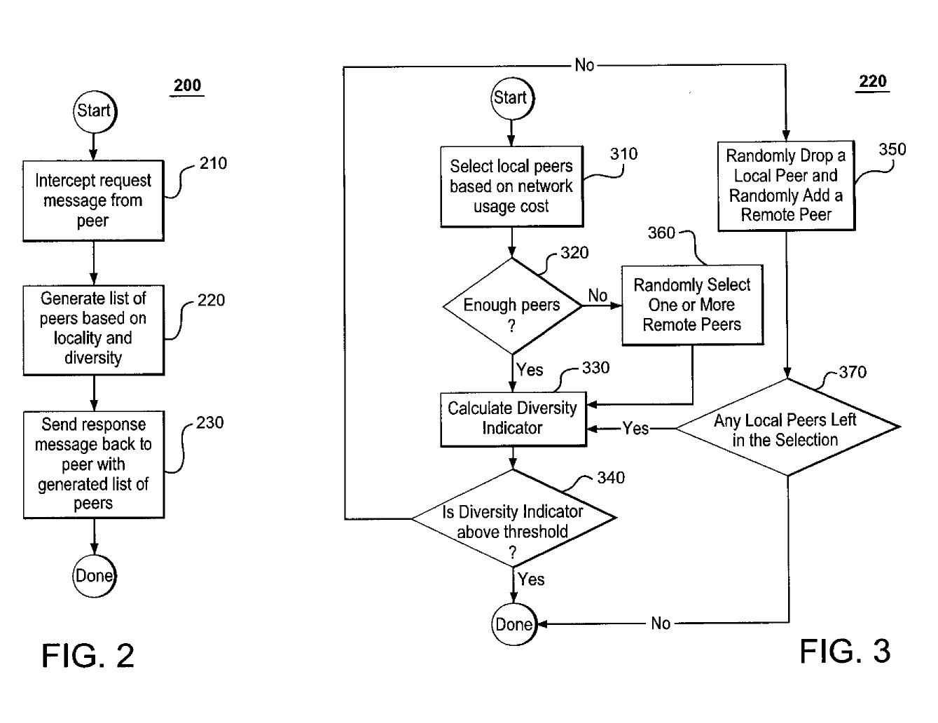

FIG. 2 shows a P2P communication optimization process 200 corresponding to various embodiments of the present invention, which are described below with reference to both FIGS. 1 and 2. In one embodiment, each router in FIG. 1 is capable of implementing process 200. In step 210, the process begins by intercepting a peer-to-tracker request message for a particular content file. For example, referring to FIG. 1, interior router 106 may implement step 210 by intercepting a request message from peer 114 to tracker 116 of autonomous system 102 for a copy of a particular content file.

Next, in step 220 of process 200, a set of peers is generated for the content file as a function of at least (i) the locality of the peers and (ii) a diversity indicator for the peers (e.g., a diversity index or an estimate of diversity). For example, interior router 106 may use a method such as the method shown in FIG. 3 (described later) to generate this list of peers as a function of network topology information and the sum of bytes of the content file of interest stored on various candidate peers.

Finally, in step 230, a response message is generated that contains the generated list of peers, and this message is sent back to the requesting peer in lieu of a response from the actual tracker. For example, interior router 106 may send a response message to peer 114 and make it look as if the message was originated by tracker 116 by spoofing in a source IP address of tracker 116 and sending the message to the appropriate port and IP address of peer 114.

In alternative embodiments, process 200 may be implemented in a distributed manner, where, for example, steps 210 and 230 are implemented by a router, such as interior router 106, while step 220 is implemented by a P2P communication optimizer (not shown) that is implemented by a device other than router 106. For example, the P2P communication optimizer may be an application running on (i) a tracker, such as tracker 116, (ii) a peer server, such as peer 120, (iii) another router, such as exterior router 110, or (iv) another host (not shown) in autonomous system 102. Alternatively, peer 114 may have registered its P2P application with a proxy host in autonomous system 102 to which all P2P traffic is directed automatically, and this proxy host may be running the P2P communication optimizer.

In any case, in these distributed implementations, (1) the request message intercepted in step 210 is forwarded from the intercepting router to the P2P communication optimizer and (2) the list of peers generated in step 220 is forwarded from the P2P communication optimizer to the router for transmission in the response message back to the peer that sent the original request message. Other distributed implementations are also possible, such as where the P2P communication optimizer performs both steps 220 and 230 or where the P2P optimizer is itself a distributed process.

FIG. 3 is an illustration of one exemplary implementation of step 220 of FIG. 2 according to some embodiments of the present invention. In step 310, a set of local peers is selected based on a measure of locality, i.e., network usage cost. For example, a P2P communication optimizer may track the activities of various peers and also keep track of the locality of these peers (as indicated by network usage cost). Network usage cost may be assessed, for example, using trace analysis of peer communications and/or by querying interior and exterior gateway protocols and/or accessing various network management and topology tools available or added to the network. Any number of different mechanisms may be used for determining the network usage costs of reaching each of these peers from any other peer as described previously. Using network usage cost, the optimizer may attempt to select a group of local peers to use in responding to a particular peer's request message to a tracker.

One way of doing this that would preserve the random nature of the peer-selection process would be to randomly choose peers from a group of candidate peers, eliminating only those that exceeded a network usage cost threshold that represents the boundary between what constitutes a local peer and what constitutes a remote peer.

Typically, a BitTorrent tracker would respond to a request message from a peer by supplying a list of about fifty randomly selected peers that have fragments of the file of interest. The P2P communication optimizer would attempt to emulate this behavior. For rare files, of course, it might not be possible to find fifty local peers, or even fifty peers independent of their locality. However, under normal circumstances, many peers will share fragments of a particular content file, and a set of local peers may be found.

If there are an insufficient number of local peers, as determined in step 320, then, in step 360, one or more remote peers are randomly selected and added to the candidate set. Following step 360, or, if, in step 320, a sufficient number of local peers was determined to have been selected, then, in step 330, a diversity indicator is calculated. For example, a diversity indicator may be calculated by summing the bytes stored by each peer as discussed previously.

In step 340, a test is done to see if this diversity indicator exceeds a predetermined threshold. For example, a threshold for a diversity indicator may have been established in advance by analysis, heuristics, or experiment, and the calculated diversity indicator may be compared with this threshold indicator to see if sufficient diversity exists in the selected peer group to keep the download time reasonable for the content file of interest while still localizing traffic and thereby minimizing network usage cost for that download. In some embodiments, this diversity-indicator threshold may be modified dynamically, e.g., by tracking the completion time of downloads or trending the downloading rates of content files, and/or benchmarking content-file downloads. In some cases, appropriate values for the diversity-indictor thresholds are arrived at by emulating and comparing the performance of both (i) a peer involved in the content-file download and subjected to the locality/diversity throttle and (ii) a peer involved in the content-file download that is free to use a traditional tracker.

If the diversity indicator exceeds the threshold, then the peer group is sufficient to provide reasonable download times, and the process completes after the test of step 340. If the diversity indicator does not exceed the threshold, then, in step 350, one of the local peers is randomly dropped in favor of a remote peer that is randomly selected. The set is then checked in step 370 to see if any local peers remain. If no local peers remain, then the process ends in FIG. 3, having done the best it can do to localize the peers. On the other hand, if one or more local peers still remain in the set, then the diversity index of the new set is calculated in step 330 and tested in step 340. This loop of steps 350, 370, 330, and 340 continues until a sufficiently diverse set of peers is identified, until no local peers remain in the set, until a network usage cost limit is reached, or until the process times out. In the latter case, an error-handling routine may be called.

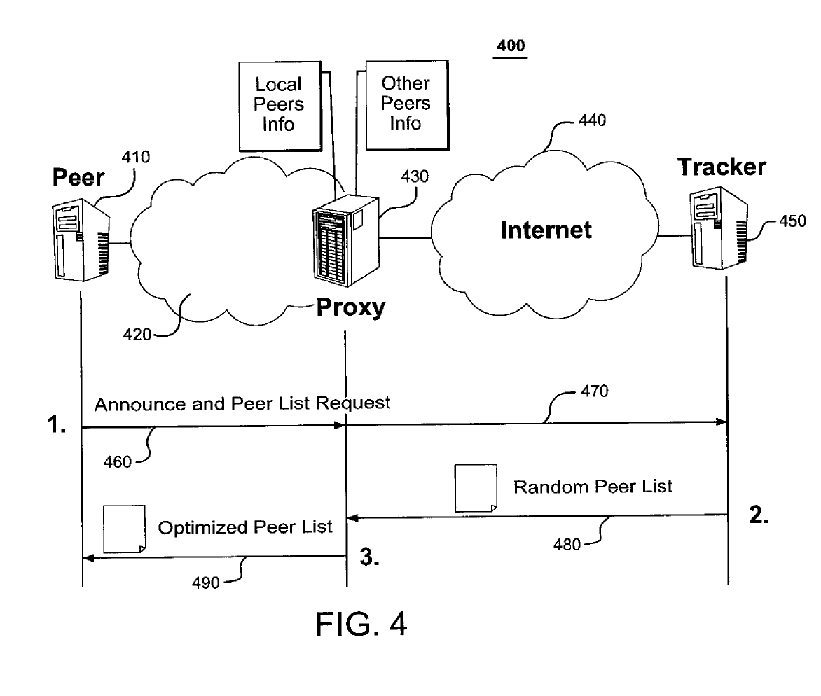

As mentioned above, some of the embodiments of the present invention utilize a proxy to intercept messages between peers or between peers and a tracker. This proxy hosts the P2P communications optimizer. This arrangement is illustrated by sequence diagram 400 of FIG. 4. Network 400 includes at least peer 410, local network 420, proxy 430, external network 440, and tracker 450. Sequence diagram 400 also illustrates the sequencing of the messaging between peer, proxy, and tracker. In particular, request message 460 originates at peer 410, travels through local network 420, and is intercepted by proxy 430, where the source IP address of peer 410 is replaced in the request message by the source IP address of proxy 430. The modified message 470 is then sent along to its original destination, tracker 450, via external network 440. Once the request message is received by the tracker, the tracker generates response message 480, which contains a random list of local and remote peers. This message is received at proxy 430 and manipulated by the P2P communications optimizer to localize the list of peers subject to content availability and diversity. For example, some remote peers may be randomly replaced by local peers, or some remote peers may just be removed from the tracker's response. The manipulated response 490 is then sent to peer 410 with the optimized peer list. In some embodiments, bytes-left information for some peers (e.g., remote peers) may not be available to the P2P communication optimizer. In such embodiments, the diversity indicator may be calculated using bytes-left information from the local peer set only. In some cases, remote peer diversity may be estimated by assuming the diversity associated with remote peers is similar to the average diversity of the local peers. In other embodiments, bytes-left information for only some remote peers may be available (e.g., those remote peers who have contacted the local tracker for content). In such cases, this information may be used in addition to local peer information and/or this information may be used to estimate diversity associated with remote peers for which bytes-left information is not explicitly available.

Proxy 430 and consequently the P2P communication optimizer are situated in the control path of the peer communication to the tracker so that the proxy may monitor content availability within local peers and intercept/manipulate control messages exchanged between the peer and the tracker. When a peer joins the network for a content file, the proxy intercepts the response of the P2P tracker (e.g., the BitTorrent tracker) and substitutes the list of contact peers generated as a function of content availability and diversity. As a result of this substitution, the probability of a peer contacting a local peer versus an external peer is shifted. For example, if the diversity of fragments of a particular content file available in the local domain is low, then the list is adjusted to contain a higher number of external peers. On the other hand, if there is a sufficient fraction of full copies locally available, then the list is adjusted to contain relatively fewer remote peers, and the probability of a peer connecting to the external world is decreased. Many of the aforementioned embodiments may be implemented transparently or nearly transparently to the P2P clients and tracker.

Note that many variations of this process exist. For example, in generating modified tracker responses, in some embodiments, only tracker responses directed to local peers may be manipulated.

In other embodiments, only tracker responses directed to remote peers may be manipulated. For example, in such an embodiment, tracker (e.g., local tracker) responses may be manipulated to reduce remote peer communications to local peers for content, but not prevent local peers from communicating to remote peers. In this latter case where only tracker responses directed to remote peers were intercepted and manipulated, the manipulation may be to remove or minimize local peers from the response list, again in agreement with the goal of minimizing network usage cost for the local network. In such embodiments where responses are directed to remote peers, there may also be agreements between ISPs or network domain operators such that these manipulations of tracker responses are done cooperatively.

For example, a second (remote) ISP may, on behalf of a first (local) ISP, intercept a remote tracker response to a remote peer and reduce, in light of a pre-arranged cooperative policy agreement, the number of peers in the response that are local to the first ISP relative to the number of peers in the response that are remote to the first ISP, thus reducing the local ISP's network usage cost.

Many of the previously discussed embodiments require no change to existing peer or tracker protocols and may be implemented by ISPs transparently to those applications. Other embodiments may involve modifications only to the tracker. These changes are transparent to the P2P client applications. In such embodiments, for example, the functionality of the P2P communication optimizer may be built into the tracker. For example, the functionality of the P2P communication optimizer running on proxy 430 of FIG. 4 could be implemented by tracker 450, and proxy 430 may be eliminated.

Work is on-going in the field to support the localization portion of P2P communications. For example, one interface being developed by the Internet Engineering Task Force (IETF), called the Application-Layer Traffic Optimization (alto) interface, is a standardized interface with which trackers, P2P communications optimizers, or P2P client applications may access network topology information. Such information may include, for example, IP-to-ISP maps. More information on the alto interface may be found at http://www.ierf.org/html.charters/alto-charter.html, the content of which is incorporated herein by reference in its entirety.

In another embodiment (not illustrated), selection of peers based on locality and diversity is performed at the application layer by the peers themselves. This embodiment involves modification to at least some peer applications and is also applicable to distributed or tracker-less implementations of P2P networks. Note that hybrid systems are supported by the present invention. For example, modified peers and trackers may be implemented in a way that they may co-exist with existing unmodified peers and trackers. For example, some ISPs may wish to encourage the use of a localization-friendly peer application and offer such an application to their clients to use in lieu of standard clients. The localization-friendly clients would mitigate the effects of the unmodified clients by favoring local peers and peers that were also localization friendly while still providing backward compatibility.

In various embodiments of the present invention, some of the local peers are designated as gateway peers. In these embodiments, only the gateway peers may connect to external or remote peers. All other peers may connect only to local peers. The gateway peers are then responsible for attracting new content fragments from external domains and dispersing them in the local domain. In these embodiments, either or both of the number of gateway peers and the peers selected in tracker responses are chosen as a function of either or both of network topology and availability/diversity of content fragments. If diversity of fragments is low, then the number of gateway peers is increased. As fragment diversity increases, the number of gateway peers may be dynamically decreased in order to reduce content redundancy and traffic on inter-domain links. Gateway peers are selected such that they optimize content exchange with external peers. For example, gateway peers may be chosen based on their content diversity since this also increases their attractiveness to external peers, which is important in a tit-for-tat environment for attracting external peers to share with the gateway peers for the benefit of the local peers. In some embodiments, gateway peers may be application-modified peers that may advertise to the outside world content available on the local peers they represent.

Though the present invention has been described with respect to specific versions of the BitTorrent protocol, as would be appreciated by one skilled in the art, various embodiments of the present invention are broadly applicable to a wide variety of P2P sharing protocols, including variants of the BitTorrent protocol that address real-time streaming of content.

The present invention may be implemented as (analog, digital, or a hybrid of both analog and digital) circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer

The present invention may be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

We claim:

1. A network-equipment-implemented method for selecting peers in a peer-to-peer (P2P) network, the method comprising:
(a) selecting a subset of peers from a set of peers as a function of both (i) diversity of content and (ii) locality; and
(b) generating a P2P control message identifying the selected subset of peers.

2. The method of claim 1, further comprising measuring the diversity of content using a diversity indicator.

3. The method of claim 1, further comprising measuring the locality using a network usage cost.

4. The method of claim 1, further comprising changing the selected subset of peers by removing a remote peer from the selected subset of peers.

5. The method of claim 1, wherein the P2P control message is structured to emulate a P2P control message generated by a tracker in the P2P network.

6. The method of claim 5, wherein the P2P control message is transmitted to a particular peer in the set of peers.

7. The method of claim 5, wherein the P2P control message is a modified copy of a P2P control message generated by a tracker in the P2P network.

8. The method of claim 1, further comprising transmitting the P2P control message to a particular peer in the set of peers.

9. The method of claim 8, wherein the particular peer is a remote peer.

10. The method of claim 1, wherein the subset of peers is selected for a particular content file.

11. The method of claim 1, the method comprising intercepting a P2P request message from a first peer in the set of peers, to a first tracker, wherein the P2P control message is sent to the first peer in place of a response from the first tracker.

12. The method of claim 1, wherein step (a) comprises:
(a1) initially selecting the subset of peers from the set of peers based on network usage cost;
(a2) determining whether the subset of peers includes a sufficient number of peers;
(a3) selecting one or more remote peers to add to the subset of peers if step (a2) determines that the subset of peers does not include a sufficient number of peers;
(a4) calculating a diversity indicator associated with the subset of peers;
(a5) comparing the diversity indicator to a specified threshold; and
(a6) selecting a remote peer to substitute for a peer in the subset of peers if step (a5) determines that the diversity indicator is below the specified threshold.

13. The method of claim 12, wherein the selecting of step (a3) is performed by adjusting a network usage cost threshold wherein the one or more remote peers that are added to the subset of peers are those that represent a network usage cost that is below the adjusted network usage cost threshold.

14. The method of claim 1, wherein the selected subset of peers includes gateway peers.

15. The method of claim 14, further comprising dynamically adjusting the number of gateway peers in the selected subset of peers as a function of the diversity of content.

16. The method of claim 1, wherein the selected subset of peers includes only local peers.

17. The method of claim 1, wherein the selected subset of peers includes only gateway and other local peers.

18. A peer-to-peer (P2P) communication optimizer comprising:
(a) means for selecting a subset of peers from a set of peers as a function of both (i) diversity of content and (ii) locality; and
(b) means for generating a P2P control message identifying the selected subset of peers.

19. A peer-to-peer (P2P) network comprising:
a set of peers; and
a P2P communication optimizer configured to:
(a) select, in response to a P2P request message transmitted from a first peer in the set, a subset of peers from the set of peers as a function of both (i) diversity of content and (i) locality; and
(b) generate a P2P control message identifying the selected subset of peers, wherein the P2P control message is transmitted to the first peer.

20. The method of claim 19, wherein the P2P communication optimizer is further configured to measure the diversity of content using a diversity indicator.
